(19) United States
(12) Patent Application Publication
(10) Pub. No.: US 2017/0154197 A1
(43) Pub. Date: Jun. 1, 2017

(54) RFIG tag, security system, and method of protecting products using the same

(71) Applicant: Chung-Ping LAI, Zhubei City (TW)

(72) Inventor: Chung-Ping LAI, Zhubei City (TW)

(21) Appl. No.: 14/952,935

(22) Filed: Nov. 26, 2015

(51) Int. Cl. G06K 7/10

(52) U.S. Cl. CPC G06K 7/10316

(57) ABSTRACT

A radio frequency identification (RFID) tag contains: a RFID tag circuit and a RFID antenna electrically connected with the RFID tag circuit. The RFID antenna includes a short circuit electrically connected therewith and includes a capacitor circuit electrically connected with the short circuit. When the capacitor circuit is not broken, the RFID antenna transmits radio signals in a second frequency band, and when the capacitor circuit is broken, the RFID antenna responds to inquiry of the RFID reader in a first frequency band and transmits the radio signals.

### FIELD OF THE INVENTION

The present invention relates to a RFIG tag, a security system, and a method of protecting products using the same which achieves theft-proof, ant-counterfeit, and security purposes.

### BACKGROUND OF THE INVENTION

A conventional method of detecting RFID tag is disclosed in CN 101128841A, and the RFID tag contains: a RFID tag circuit configured to receive and transmit RF signals, a RFID antenna, a security sensor configured to fix on a container, and a tag register for storing tag codes, and an operating circuit for indicating operation of the security sensor. After the container is opened, the security sensor and a continuous loop are broken, and a RFID reader inquiries operating state of the security sensor, thus determining a change of the container.

A conventional RFID tag is disclosed in CN 203025749U and is attached on a container, the RFID tag contains a flexible substrate on which a pattern, characters, and symbols are remarked. The flexible substrate has at least one spacing line extending across an open position of the container so as to check if the container is opened or broken. The flexible substrate has a RFID antenna printed thereon, a RF chip, and a conduct loop extending through the spacing line so as to identify radio frequency and to provide current state of the container by using a reader. After the container is opened or broken, the conduct loop of the spacing line detects the container is opened, the RF chip stores updated state of the container, and the RF signals are sent to the reader, after the reader inquiries the updated state.

A detection system and method are disclosed in CN 100409254C and contains a passive electronic sensor. The sensor has a circuit apparatus, a load connected between a first contact and a second contact of the circuit apparatus, and a connector fixed between the second contact and a third contact of the circuit apparatus. The first contact and the third contact supply voltage, wherein when the connector is not broken, the second contact is in a first voltage, and when the connection apparatus is broken, the second contact is in a second voltage. When a voltage change of the second contact happens, a code of the passive electronic sensor changes.

An active tag is disclosed in CN 1950860A and contains data circuit for storing identification information and plural antennas coupling with the data circuit, wherein at least one of the plural antennas is removable as transmitting wireless signals in a first range so as to avoid transmission of the identification information, and another of the plural antennas sends the identification information in a second range less than the first range.

The present invention has arisen to mitigate and/or obviate the afore-described disadvantages.

### SUMMARY OF THE INVENTION

The primary objective of the present invention is to provide a RFIG tag, a security system, and a method of protecting products using the same which achieves theft-proof, ant-counterfeit, and security purposes.

To obtain above objective, a radio frequency identification (RFID) tag provided by the present invention contains: a RFID tag circuit and a RFID antenna electrically connected with the RFID tag circuit.

The RFID antenna includes a short circuit electrically connected therewith and includes a capacitor circuit electrically connected with the short circuit, when the capacitor circuit is not broken, the RFID antenna transmits radio signals in a second frequency band, and when the capacitor circuit is broken, the RFID antenna responds to inquiry of the RFID reader in a first frequency band and transmits the radio signals.

A security system provided by the present invention contains: a RFID tag, a RFID reader, and a photography device electrically connected with the RFID reader.

The RFID tag includes a RFID tag circuit and a RFID antenna electrically connected with the RFID tag circuit.

The RFID antenna includes a short circuit electrically connected therewith and includes a capacitor circuit electrically connected with the short circuit, when the capacitor circuit is not broken, the RFID antenna transmits radio signals in a second frequency band, and when the capacitor circuit is broken, the RFID antenna responds to inquiry of the RFID reader in a first frequency band and transmits the radio signals.

When the RFID tag responds to the inquiry of the RFID reader in the first frequency band, the RFID reader starts the photography device to take a photograph.

A method of protecting products by using a RFID tag comprises steps of:

A. attaching a RFID tag on a product so that a capacitor circuit of the RFID tag passes across a seal position or an open position of a product;

B. receiving inquiry of a RFID reader by using the RFID tag; and

C. responding to the inquiry of the RFID reader by way of the RFID tag after the product is opened or broken.

### BRIEF DESCRIPTION OF THE DRAWINGS

FIG. 1 is a block diagram showing the functions of a radio frequency identification (RFID) tag according to a preferred embodiment of the present invention

FIG. 2 is a schematic view illustrating the operation of the RFID tag according to the preferred embodiment of the present invention.

FIG. 3 is a schematic diagram illustrating impedance matching factor against frequency of the RFID tag according to the preferred embodiment of the present invention.

FIG. 4 is another schematic diagram illustrating impedance matching factor against frequency of the RFID tag according to the preferred embodiment of the present invention.

FIG. 5 is a block diagram showing the functions of a security system of the RFID tag according to the preferred embodiment of the present invention.

FIG. 6 is a schematic view illustrating the operation of the security system according to the preferred embodiment of the present invention.

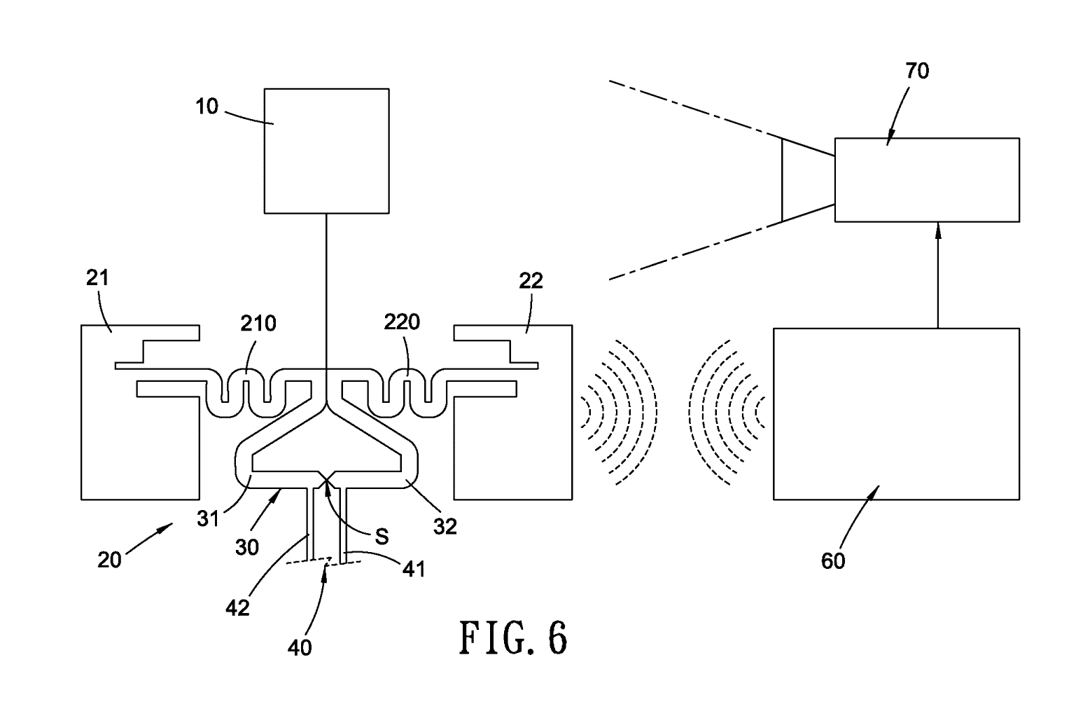

FIG. 7 is a schematic diagram showing the application of the RFID tag according to the preferred embodiment of the present invention.

### DETAILED DESCRIPTION OF THE PREFERRED EMBODIMENTS

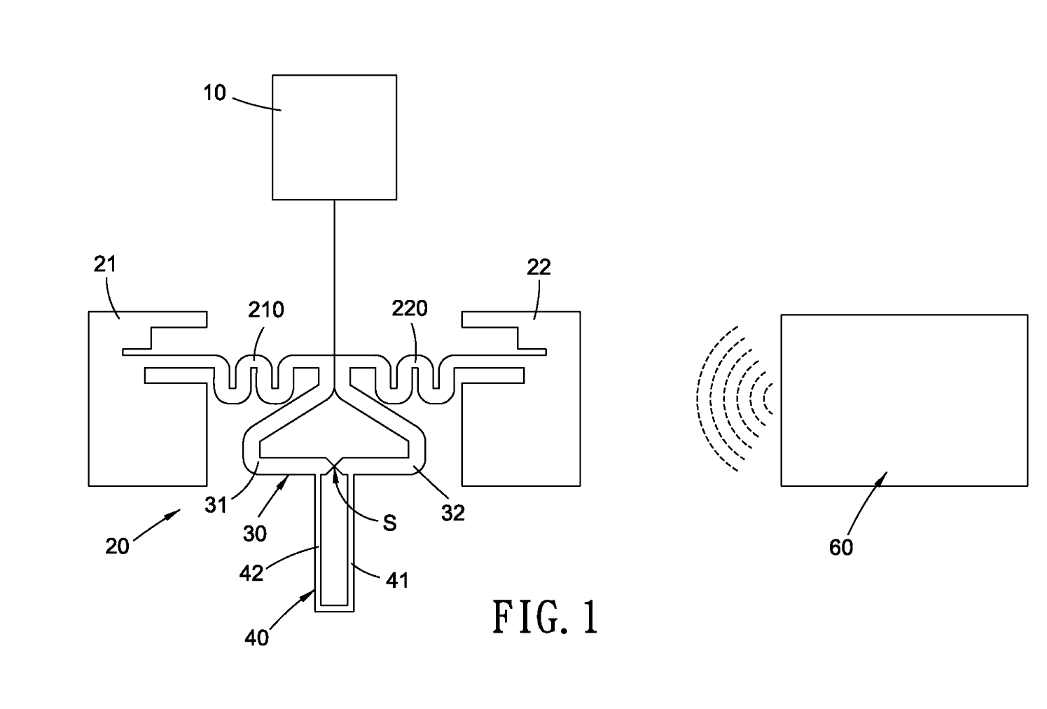

With reference to FIG. 1, a radio frequency identification (RFID) tag according to a preferred embodiment of the present invention comprises: a RFID tag circuit 10 and a RFID antenna 20 electrically connected with the RFID tag circuit 10. The RFID tag circuit 10 is configured to store data (including product information) and processing signals), and the RFID tag circuit 10 forms in a chip configuration. The RFID tag circuit 10 is any one of an active tag, a semi-passive tag, and a passive tag. In this embodiment, the RFID tag circuit 10 is a passive tag and its operating frequency is any one of high frequency (HF), ultra high frequency (UHF), and micro wave.

The RFID antenna 20 is made of a conductive material and is configured on one surface of a flexible film, such as polyethylene terephthalate (PET) film, and the RFID antenna 20 is made of the conductive material in any one of a printing manner, an etching manner, a plating manner, and a metal foil attaching manner.

The RFID antenna 20 includes a first radiator 21 and a second radiator 22 symmetrical to the first radiator 21, the first radiator 21 has a first wave section 210, and the second radiator 22 has a second wave section 220. The RFID antenna 20 also includes a short circuit 30 electrically connected therewith and includes a capacitor circuit 40 electrically connected with the short circuit 30, and the short circuit 30 has a first circuit section 31 and a second circuit section 32, a front end of the first circuit section 31 is electrically connected with the RFID antenna 20, a front end of the second circuit section 32 is electrically connected with the RFID antenna 20, a distal end of the first circuit section 31 is connected with a distal end of the second circuit section 32 on a short circuit contact S of the short circuit 30 so as to form the short circuit 30. Two ends of the capacitor circuit 40 extend toward two ends of the short circuit contact S. The capacitor circuit 40 includes a third circuit section 41 and a fourth circuit section 42 parallel to the third circuit section 41, a distal end of the third circuit section 41 connects or contacts with a distal end of the fourth circuit section 42 so as to form a capacitor circuit, and a front end of the third circuit section 41 and a front end of the fourth circuit section 42 extend toward the two ends of the short circuit contact S of the short circuit 30.

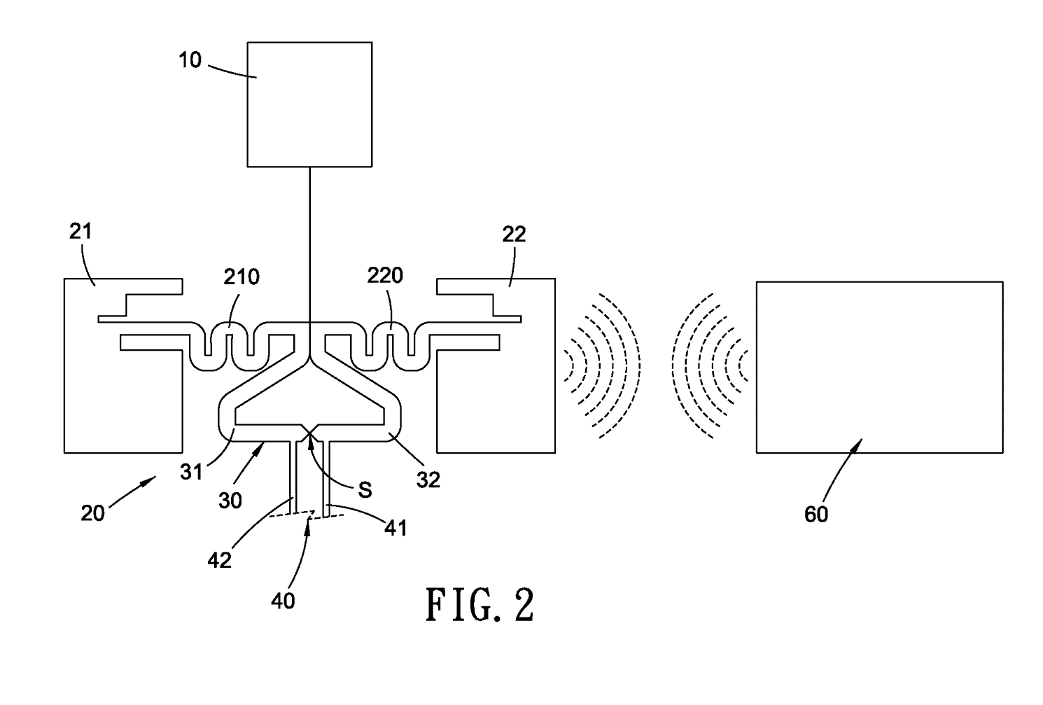

When the RFID tag circuit 10 conducts electricity, the capacitor circuit 40 produces parasitic capacitance in parasitic effect, and the RFID antenna 20 transmits radio signals in a second frequency band and does not respond inquiry from a RFID reader 60. When the capacitor circuit 40 is broken and the RFID tag circuit 10 operates, the RFID antenna 20 responds to the inquiry of the RFID reader 60 in a first frequency band and transmits the radio signals, as illustrated in FIG. 2.

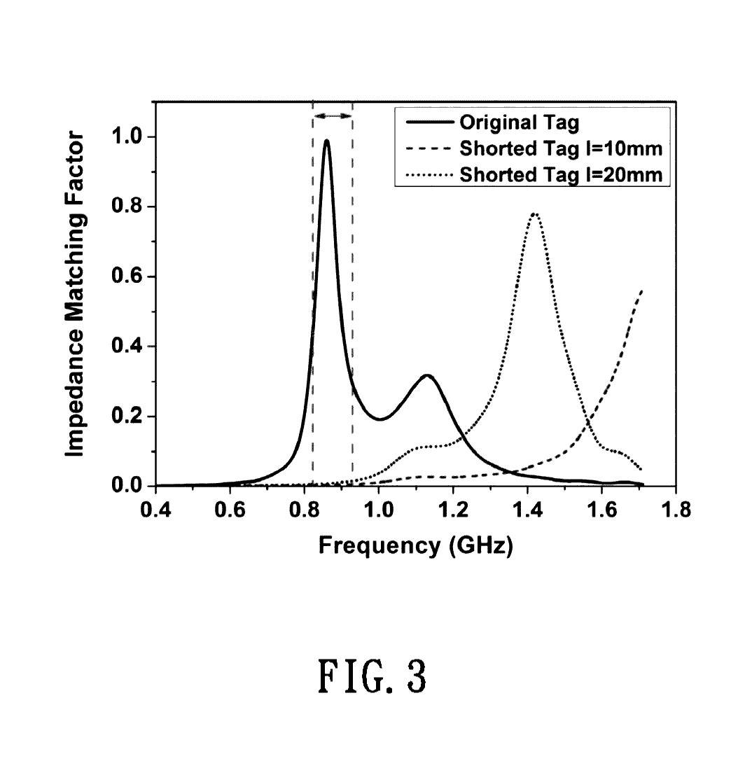

FIG. 3 is a schematic diagram illustrating impedance matching factor against frequency of the radio frequency identification (RFID) tag according to the preferred embodiment of the present invention, wherein a first curve is denoted by a solid line, a second curve is depicted by consecutive dots, and a third curve is represented by a dotted line. The RFID antenna 20 responds the inquiry of the RFID reader 60 in the first frequency band of ultra high frequency (UHF), and the inquiry of the RFID reader 60 contains radio signals between the RFID reader 60 and the RFID tag, the first frequency band ranges from 840 MHz to 928 MHz, as shown by the first curve in FIG. 3.

When the capacitor circuit 40 of the RFID antenna 20 is not broken, it produces the parasitic capacitance in the parasitic effect so that impedance matching factor of the RFID antenna 20 reduces less than 0.02, and resonance frequency of the RFID tag deviates from the second frequency band in which the RFID antenna 20 responds to the inquiry of the RFID reader 60. A length 1 of each of the third circuit section 41 and the fourth circuit section 42 of the capacitor circuit 40 is within 2 mm to 200 mm. It is preferable that the length l is 20 mm.

As shown in FIG. 3, the length 1 of the third circuit section 41 is 10 mm, and the length l of the fourth circuit section 42 is 20 mm so as to change frequency in the second frequency band, wherein the second curve represents the impedance matching factor against the frequency when the length l is 20 mm, and the third curve represents the impedance matching factor against the frequency when the length l is 10 mm. Thereby, the RFID tag of the present invention is attached on a product and the capacitor circuit 40 passes across a seal position or an open position of the product so that the RFID tag responds to the inquiry of the RFID reader 60 after the product is opened or broken, thus obtaining theft-proof, ant-counterfeit, and security purposes.

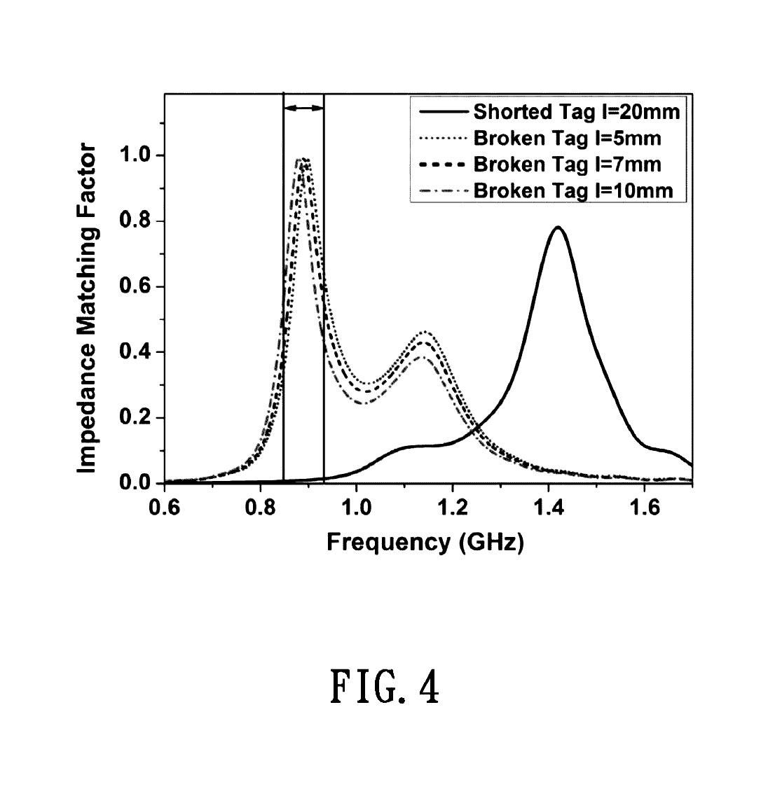

As illustrated in FIG. 4, the length 1 of each of the third circuit section 41 and the fourth circuit section 42 is 20 mm, when the capacitor circuit 40 is not broken. After the capacitor circuit 40 is broken to change the length l, the impedance matching factor of the RFID antenna 20 changes, but the short circuit 30 of the RFID antenna 20 transmits the radio signals in the first frequency band (i.e., 840 to 928 MHz) in which the RFID antenna 20 responds to the inquiry of the RFID reader 60.

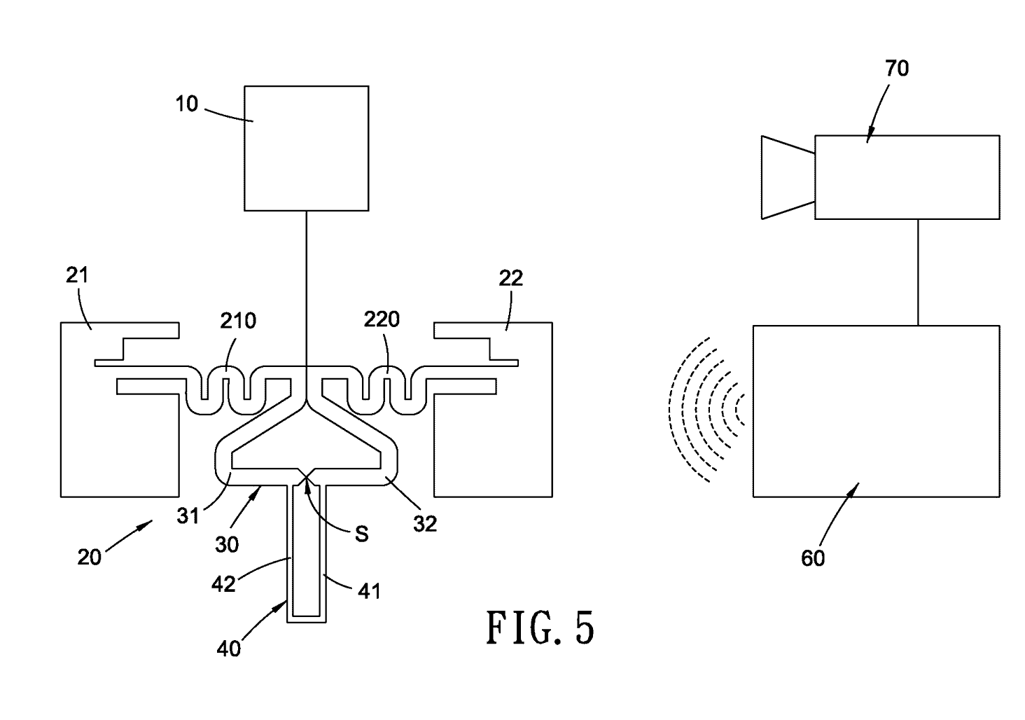

FIG. 5 is a block diagram showing the functions of a security system according to the preferred embodiment of the present invention. The security system comprises: the RFID tag, the RFID reader 60, and a photography device 70 electrically connected with the RFID reader 60, wherein the photography device 70 is a digital camera or a digital video camera. When the RFID tag responds to the inquiry of the RFID reader 60 in the first frequency band, the RFID reader 60 starts the photography device 70 to take a photograph, such that when the product is opened or broken, the RFID tag responds to the inquiry of the RFID reader 60, and the RFID reader 60 starts the photography device 70 to take the photograph, thus obtaining theft-proof, ant-counterfeit, and security purposes.

A method of protecting products by using the RFID tag comprises steps of:

A. attaching the RFID tag on the product so that the capacitor circuit of the RFID tag passes across the seal position or the open position of the product;

B. receiving inquiry of the RFID reader by using the RFID tag; and

C. responding to the inquiry of the RFID reader by way of the RFID tag after the product is opened or broken.

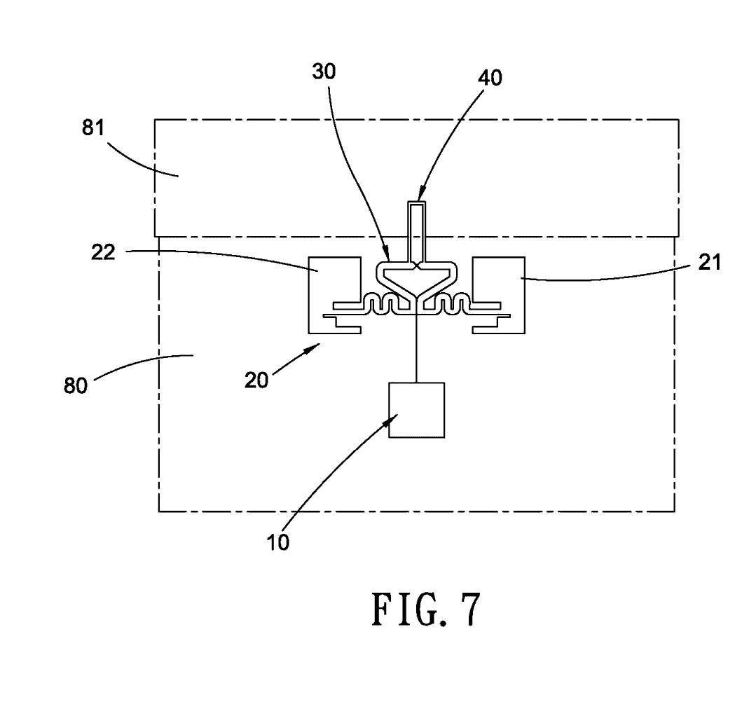

With reference to FIG. 7, the RFID tag is attached on a container 80, wherein the capacitor circuit 40 of the RFID antenna 20 passes across the seal position or the open position of the product (for example, the capacitor circuit 40 passes across an peripheral side of a cover 81 of the container 80) so that the RFID tag responds to the inquiry of the RFID reader 60 after the product is opened or broken, thus obtaining theft-proof, ant-counterfeit, and security purposes.

When the RFID tag responds to the inquiry of the RFID reader 60, it transmits electronic signals of product information toward the RFID reader 60.

When the product is opened or broken, the RFID tag responds to the inquiry of the RFID reader 60 by transmitting the radio signals toward the RFID reader 60 in the first frequency band.

When the capacitor circuit 40 of the RFID antenna 20 is not broken, the RFID tag does not respond to the inquiry of the RFID reader 60 and the RFID antenna 20 transmits the radio signals in the second frequency band, wherein the first frequency band is different from the second frequency band.

The method of protecting products by using the RFID tag further comprises a step of starting the photography device 70 to take the photography when the RFID tag responds to the inquiry of the RFID tag 60. Accordingly, when the product is opened or broken, the RFID reader 60 reads a response from the RFID tag and starts the photography device 70 to take the photography, thus obtaining theft-proof, ant-counterfeit, and security purposes.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A radio frequency identification (RFID) tag comprising: a RFID tag circuit and a RFID antenna electrically connected with the RFID tag circuit;
wherein the RFID antenna includes a short circuit electrically connected therewith and includes a capacitor circuit electrically connected with the short circuit, when the capacitor circuit is not broken, the RFID antenna transmits radio signals in a second frequency band, and when the capacitor circuit is broken, the RFID antenna responds to inquiry of the RFID reader in a first frequency band and transmits the radio signals.

2. The RFID tag as claimed in claim 1, wherein the short circuit has a first circuit section and a second circuit section, a front end of the first circuit section is electrically connected with the RFID antenna, a front end of the second circuit section is electrically connected with the RFID antenna, and a distal end of the first circuit section is connected with a distal end of the second circuit section on a short circuit contact of the short circuit so as to form the short circuit, wherein two ends of the capacitor circuit extend toward two ends of the short circuit contact.

3. The RFID tag as claimed in claim 2, wherein the capacitor circuit includes a third circuit section and a fourth circuit section parallel to the third circuit section, a distal end of the third circuit section connects or contacts with a distal end of the fourth circuit section so as to form a capacitor circuit, and a front end of the third circuit section and a front end of the fourth circuit section extend toward the two ends of the short circuit contact of the short circuit.

4. The RFID tag as claimed in claim 3, wherein a length of each of the third circuit section and the fourth circuit section of the capacitor circuit is within 2 mm to 200 mm.

5. The RFID tag as claimed in claim 4, wherein the length is 20 mm.

6. A security system comprising: a RFID tag, a RFID reader, and a photography device electrically connected with the RFID reader;
wherein the RFID tag includes a RFID tag circuit and a RFID antenna electrically connected with the RFID tag circuit;
wherein the RFID antenna includes a short circuit electrically connected therewith and includes a capacitor circuit electrically connected with the short circuit, when the capacitor circuit is not broken, the RFID antenna transmits radio signals in a second frequency band, and when the capacitor circuit is broken, the RFID antenna responds to inquiry of the RFID reader in a first frequency band and transmits the radio signals;
wherein when the RFID tag responds to the inquiry of the RFID reader in the first frequency band, the RFID reader starts the photography device to take a photograph.

7. The RFID tag as claimed in claim 6, wherein the short circuit has a first circuit section and a second circuit section, a front end of the first circuit section is electrically connected with the RFID antenna, a front end of the second circuit section is electrically connected with the RFID antenna, and a distal end of the first circuit section is connected with a distal end of the second circuit section on a short circuit contact of the short circuit so as to form the short circuit, wherein two ends of the capacitor circuit extend toward two ends of the short circuit contact.

8. The RFID tag as claimed in claim 7, wherein the capacitor circuit includes a third circuit section and a fourth circuit section parallel to the third circuit section, a distal end of the third circuit section connects or contacts with a distal end of the fourth circuit section so as to form a capacitor circuit, and a front end of the third circuit section and a front end of the fourth circuit section extend toward the two ends of the short circuit contact of the short circuit.

9. The RFID tag as claimed in claim 6, wherein the photography device is a digital camera or a digital video camera.

10. A method of protecting products by using a RFID tag comprises steps of:
A. attaching a RFID tag on a product so that a capacitor circuit of the RFID tag passes across a seal position or an open position of a product;
B. receiving inquiry of a RFID reader by using the RFID tag; and
C. responding to the inquiry of the RFID reader by way of the RFID tag after the product is opened or broken.

11. The method as claimed in claim 10, wherein the RFID tag includes a RFID tag circuit and a RFID antenna electrically connected with the RFID tag circuit, and the RFID antenna includes the capacitor circuit passing across the seal position or the open position of the product.

12. The method as claimed in claim 11, wherein the RFID antenna further includes a short circuit electrically connected with the RFID antenna, and the capacitor circuit is electrically connected with the short circuit, when the capacitor circuit is not broken, the RFID antenna transmits radio signals in a second frequency band, and when the capacitor circuit is broken, the RFID antenna responds to the inquiry of the RFID reader in a first frequency band and transmits the radio signals.

13. The method as claimed in claim 10 further comprising a step of transmitting electronic signals of product information toward the RFID reader, when the RFID tag responds to the inquiry of the RFID reader.

14. The method as claimed in claim 10 further comprising a step of starting a photography device to take a photography when the RFID tag responds to the inquiry of the RFID tag.
